(19) United States
(12) Patent Application Publication
(10) Pub. No.: US 2006/0086307 A1
(43) Pub. Date: Apr. 27, 2006

(54) Apparatus for locating a vehicle

(76) Inventor: Maurice A. Kaz, Davis, CA (US)

Correspondence Address: JAMES RAY & ASSOCIATES, 2640 PITCAIRN ROAD, MONROEVILLE, PA, 15146, US

(21) Appl. No.: 11/252,016

(22) Filed: Oct. 17, 2005

Related U.S. Application Data
(60) Provisional application No. 60/621,367, filed on Oct. 23, 2004.

(51) Int. Cl. E04H 6/42; G09F 21/04

(52) U.S. Cl. 116/28 R; 116/173; 116/209; 40/591; 40/592; 40/600

(57) ABSTRACT

Vehicle locating apparatus comprising a plurality of elongated sub members each having first and second ends. The first and second ends each have a mechanism for connecting a first end of one to a second end of another to form a single member having a third and fourth end with a first attachment device disposed near the third end. A third device engageable with the fourth end of the single member attaches apparatus to the vehicle. A fourth device is disposed either on or in the third device for engagement with the fourth end of the single member for removeably securing the single member perpendicular to the fourth device. A signaling element has a second attachment device engageable with the first attachment device on the single member for mounting the signaling element thereon. The signaling element can be viewed from a distance to easily locate a vehicle when the apparatus is attached thereto.

### CROSS-REFERENCE TO RELATED APPLICATIONS

This application is related to and claims priority from a provisional patent application Ser. 60/621,367 filed on Oct. 23, 2004.

### FIELD OF INVENTION

The present invention relates, in general, to a vehicle, and more particularly, to an apparatus for locating a vehicle.

### BACKGROUND OF THE INVENTION

Prior to the present invention, vehicle locator devices are designed for a maximum height and are not adjustable; therefore, they are useful only on automobiles. The mast is also rigidly attached to the base, which prevents height adjustability or removal of the mast from the base when the locating device is not being used. An example of this type of locating device is taught in U.S. Pat. No. 5,388,546. The teachings of this reference are incorporated herein by reference thereto.

### SUMMARY OF THE INVENTION

In a first aspect, the present invention provides an apparatus for locating a vehicle. The apparatus comprises a plurality of elongated sub members of a predetermined size, shape, and material. Each sub member has a first end and a second end, and each first end has a first means and each second end further has a second means for axially connecting one of each first end to one of each second end, whereby the sub members form a single member. The single member has a third end and a fourth end, and a first attachment means substantially disposed near the third end of the single member. A third means is engageable with the single member and the vehicle for attaching the apparatus to the vehicle. A fourth means is disposed one of on and in the third means for engagement with the fourth end of the single member for removeably securing the fourth end of the single member perpendicular to the fourth means. A signaling element of a predetermined size, shape, and material has a second attachment means engageable with the first attachment means on the single member for mounting the signaling element on the single member. The signaling element of the apparatus can be viewed from a distance when the apparatus is attached to a vehicle.

### OBJECTS OF THE INVENTION

It is therefore the primary object of the present invention to provide an apparatus for locating a vehicle in a previously parked location.

Another object of the present invention is to provide for adjustability of height of the apparatus for use on any vehicle.

Another object of the present invention is to provide a means for easily removing the apparatus from a vehicle without removing the mounting means from the vehicle.

In addition to the various objects of the invention that have been described above, various other objects and advantages of the invention will become more readily apparent to those persons skilled in the relevant art from the following more detailed description of the invention, particularly, when such description is taken in conjunction with the attached drawing figures and the appended claims.

### BRIEF DESCRIPTION OF THE DRAWINGS

FIG. 1 is a detailed view of the apparatus for locating a vehicle;

FIG. 2 is a detailed view of a portion of the apparatus for locating a vehicle;

FIG. 3 is a vertical section view of a portion of the apparatus for locating a vehicle taken along the lines III-III of FIG. 2;

FIG. 4 is a vertical view of an assembly of a portion of the apparatus for locating a vehicle;

FIG. 5 is a top view of a portion of the apparatus for locating a vehicle;

FIG. 6 is a vertical section view taken along the lines of VI-VI of FIG. 5;

FIG. 7 is a vertical view of a portion of an alternate design for an apparatus for locating a vehicle;

FIG. 8 is a vertical view of an assembly of a portion of an alternate design for an apparatus for locating a vehicle as shown in FIG. 7.

### BRIEF DESCRIPTION OF A PRESENTLY PREFERRED AND VARIOUS ALTERNATIVE EMBODIMENTS OF THE PRESENT INVENTION

Prior to proceeding to a more detailed description of the invention, it should be noted that identical components having identical functions have been designated with identical reference numbers for the sake of clarity.

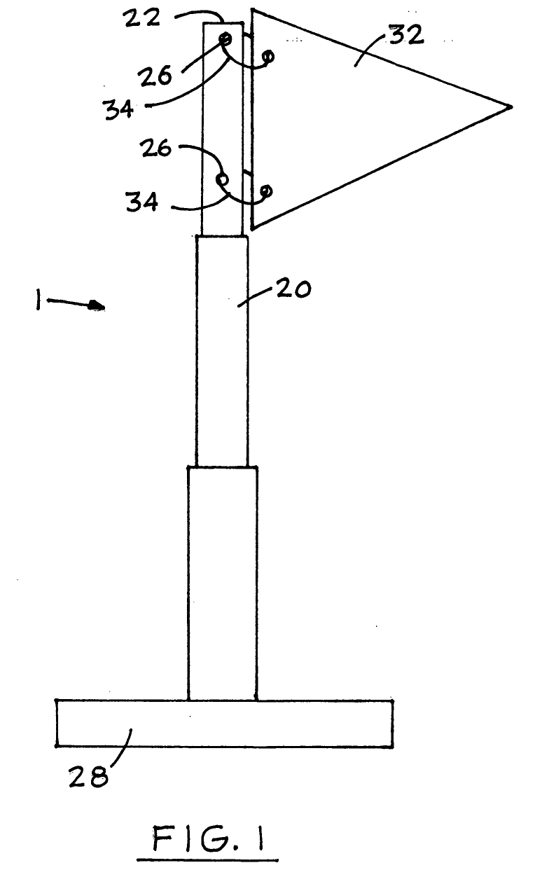

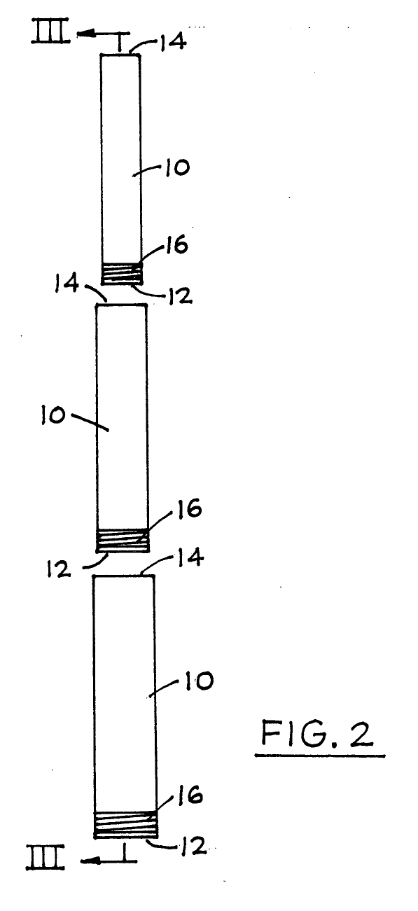

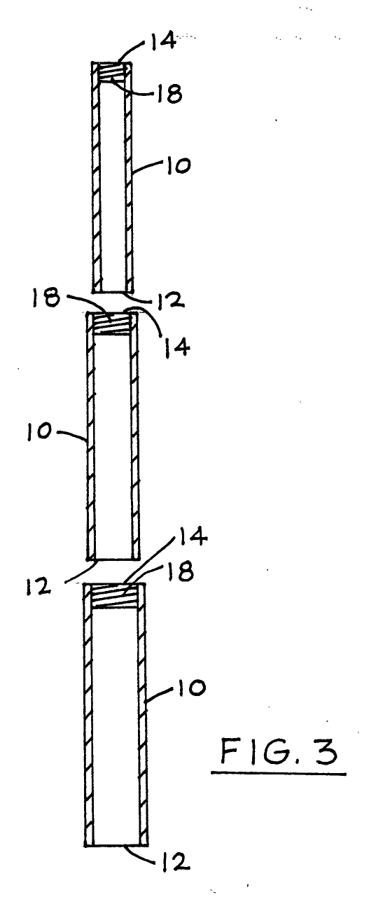

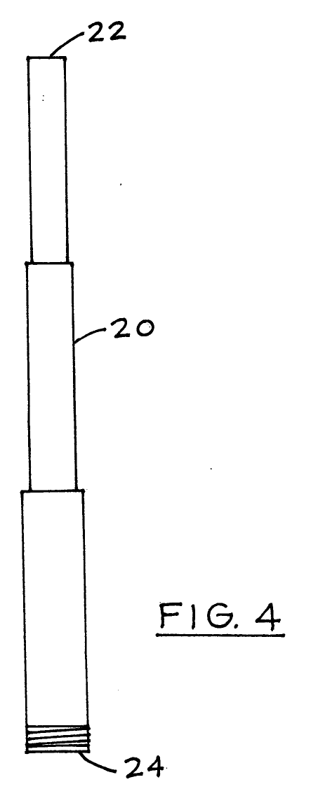

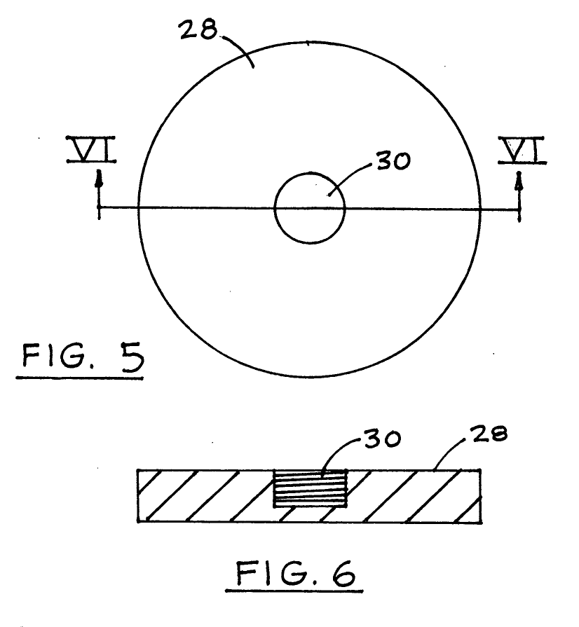

Now refer more particularly to FIGS. 1, 2, 3, 4, 5, and 6 of the drawings. Illustrated therein is an apparatus for locating a vehicle, generally designated 1. The apparatus comprises a plurality of elongated sub members 10 of a predetermined size, shape, and material. Preferably, the plurality of the sub members 10 is two, however, additional sub members can be added as required to achieve the desired height. Preferably, the shape of the sub members is tubular, and the material is at least one of plastic and metal. Preferably, the material is plastic for lightness and durability. Each sub member has a first end 12 and a second end 14. Each first end 12 further has a first means 16, and each second end 14 further has a second means 18 for axially connecting one of each first end 12 to one of each second end 14. Preferably, the first means 16 includes external threads of a predetermined size disposed on the first end 12 of each sub member 10, and the second means 18 includes internal threads of a predetermined size disposed on each second end 14 of the sub member 10. The external threads on each first end 12 of the sub member 10 are engaged with the internal threads of each second end 14 of an adjacent sub member 10. The sub members 10 form a single member 20. The single member 20 has a third end 22 and a fourth end 24. A first attachment means 26 is substantially disposed near the third end 22 of the single member 20. Preferably, the first attachment means 26 is at least one of an aperture, clew, ring, eyebolt, grommet, and Velcro® of a predetermined size and shape. Preferably, the first attachment means 26 is an aperture of a predetermined size and shape. A third means 28 is engageable with the single member 20 and the vehicle for attaching the apparatus 1 to the vehicle. Preferably, the third means 28 is a magnetic element of a predetermined thickness, having various sizes for being adaptable to a variety of vehicles. The vehicles include, but are not limited to automobiles, boats, trucks, motorcycles, and bicycles. Preferably, the thickness of the magnetic element is generally about 0.75 inch. A fourth means 30 is disposed one of on and in the third means 28 for engagement with the fourth end 24 of the single member 20 for removeably securing the fourth end 24 of the single member 20 perpendicular to the fourth means 30. Preferably, the fourth means 30 is an aperture of a predetermined size, shape and depth. Preferably, the shape of the aperture is circular, the size of the aperture is generally about one-inch diameter, and the aperture includes internal threads of a predetermined size for receiving and securing the external threads of the fourth end 24 of the single member 20. A signaling element 32 of a predetermined size, shape, and material has a second attachment means 34 engageable with the first attachment means 26 on the single member 20 for mounting the signaling element 32 on the single member 20. Preferably, the signaling element 32 is at least one of a flag and pennant. Preferably, the signaling element 32 is a pennant. The pennant can be of various colors, can contain an emblem or logo depicting, for example, a specific organization or school, and can be of various sizes. The second attachment means 26 preferably includes at least one of a clip, ring, clasp, hook, bolt, spring snap, trigger snap, and Velcro® of a predetermined size and shape. Preferably, the second attachment means 26 is a ring. A spring snap, trigger snap, and Velcro® can be useful when it is desirable for the pennant to be interchangeable and removed for the purpose of changing to one a different color, emblem or logo design, or size.

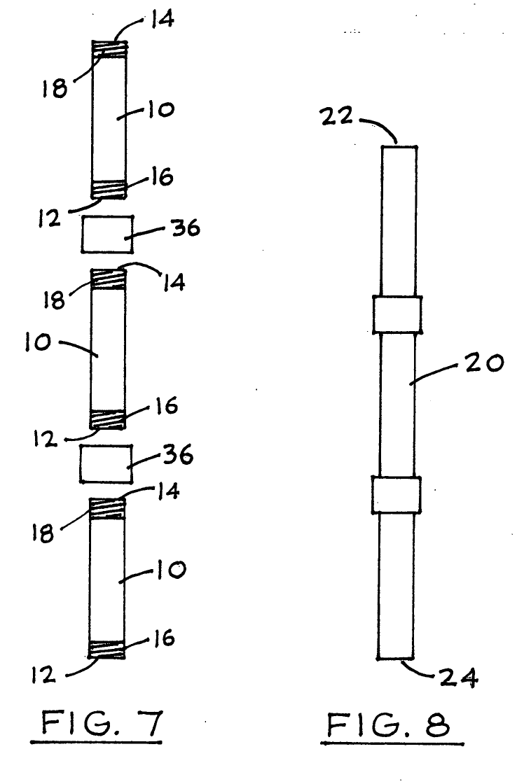

Now refer more particularly to FIGS. 7 and 8 of the drawings. Illustrated therein is an alternate means for axially connecting the plurality of sub members 10 to form a single member 20. The sub members 10 are of equal size and shape. Preferably, the shape is tubular. The first means 16 and the second means 18 of each sub member 10 include external threads of a predetermined size disposed on the first end 12 and the second end 14 of the sub members 10. A plurality of connectors 36 of a predetermined size, and having internal threads of a predetermined size are threadably disposed intermediate one each of said first end 12 of the sub member 10 and the second end 14 of an adjacent sub member 10.

Although the invention has been shown in connection with a certain specific embodiment, it will be readily apparent to those skilled in the art that various changes in form and arrangement of parts may be made to suit requirements without departing from the spirit and scope of the invention.

I claim:

1. An apparatus for locating a vehicle, comprising:
(a) a plurality of elongated sub members of a predetermined size, shape, and material, each said sub member having a first end and a second end, each said first end having a first means and said second end having a second means for axially connecting one of each said first end to one of each said second end, whereby said sub members form a single member, said single member further having a third end and a fourth end;
(b) a first attachment means substantially disposed near said third end of said single member;
(c) a third means engageable with said fourth end of said single member and such vehicle for attaching said apparatus to such vehicle,
(d) a fourth means disposed one of on and in said third means for engagement with said fourth end of said single member for removeably securing said fourth end of said single member perpendicular to said fourth means;
(e) a signaling element of a predetermined size, shape, and material; and
(f) said signaling element having a second attachment means engageable with said first attachment means on said single member for mounting said signaling element on said single member, whereby said signaling element of said apparatus can be viewed from a distance, thereby allowing a person to easily locate a vehicle when said apparatus is attached to such vehicle.

2. An apparatus according to claim 1, whereby said plurality of said sub members is at least two.

3. An apparatus according to claim 1, whereby said shape of said elongated sub members is tubular.

4. An apparatus according to claim 1, whereby said material of said sub members is at least one of plastic and metal.

5. An apparatus according to claim 4 whereby said material of said sub members is plastic.

6. An apparatus according to claim 1 whereby said first means includes external threads of a predetermined size disposed on said first end of each said sub member, and said second means includes internal threads of a predetermined size disposed on each of said second end of said sub member.

7. An apparatus according to claim 6 whereby said external threads of each said first end of said sub member are engaged with said internal threads of each said second end of an adjacent said sub member.

8. An apparatus according to claim 1, whereby said first attachment means includes at least one of an aperture, clew, ring, eyebolt, grommet, and hook and loop type fastener of a predetermined size and shape.

9. An apparatus according to claim 8, whereby said first attachment means is an aperture and a ring of a predetermined size and shape.

10. An apparatus according to claim 1, whereby said third means is a magnetic element having various sizes for being adaptable to a variety of vehicles, said magnetic element further having a predetermined thickness.

11. An apparatus according to claim 10, whereby said magnetic element is a disc having a thickness generally about 0.75 inch.

12. An apparatus according to claim 1, whereby said fourth means disposed one of on and in said magnetic element for engagement with said bottom end of said magnetic element is an aperture of a predetermined size, shape and depth.

13. An apparatus according to claim 12, whereby shape of said aperture is circular.

14. An apparatus according to claim 13, whereby the size of said aperture is substantially one-inch diameter.

15. An apparatus according to claim 14, whereby said aperture includes internal threads of a predetermined size for receiving and securing said external threads of said fourth end of said single member.

16. An apparatus according to claim 1, whereby said signaling element is at least one of a flag and pennant.

17. An apparatus according to claim 16, whereby said signaling device is a pennant.

18. An apparatus according to claim 1, whereby said second attachment means for said signaling element includes at least one of a clip, ring, clasp, hook, bolt snap, spring snap, trigger snap, and hook and loop type fastener of a predetermined size and shape.

19. An apparatus according to claim 17, whereby said second attachment means is a spring snap.

20. An apparatus according to claim 1 whereby said first means and said second means include external threads of a predetermined size disposed on said first end and said second end of said sub members.

21. An apparatus according to claim 1 whereby said apparatus includes a plurality of connectors of a predetermined size, said connectors further having internal threads of a predetermined size, said connectors further being threadably disposed intermediate one each of said first end of said sub member and said second end of an adjacent said sub member.
